(19) United States
(12) Patent Application Publication
(10) Pub. No.: US 2026/0258736 A1
(43) Pub. Date: Sep. 3, 2026

(54) BLADE DE-ICING DEVICE

(71) Applicant: SAFRAN AIRCRAFT ENGINES, Paris (FR)

(72) Inventors: Hugo CARTRON, Moissy-Cramayel (FR); Julien David Alexandre TREBAOL, Moissy-Cramayel (FR); Henri OUTTRABADY, Moissy-Cramayel (FR)

(73) Assignee: SAFRAN AIRCRAFT ENGINES, Paris (FR)

(21) Appl. No.: 18/846,714

(22) PCT Filed: Mar. 14, 2023
(86) PCT No.: PCT/FR2023/050332

§ 371 Date: Sep. 13, 2024

(30) Foreign Application Priority Data
Mar. 14, 2022 (FR) FR2202211

(51) Int. Cl. F01D 25/02; B64C 11/26; F01D 5/28

(52) U.S. Cl. CPC F01D 25/02; B64C 11/26; F01D 5/282; F05D 2220/323; F05D 2300/603

(57) ABSTRACT

An aircraft part includes a composite material structure including a fibrous reinforcement and matrix, the fibrous reinforcement being embedded into the matrix, and heating elements that heat the aircraft part, each of the heating elements being embedded into the matrix of the composite material structure and being distributed across the aircraft part with a density depending on a position in the aircraft part.

### FIELD OF THE INVENTION

The present application relates to the field of aeronautics. More specifically, the present application relates to the de-icing of parts of an aircraft, typically composite material parts, and more particularly aircraft engine blades.

### STATE OF THE ART

Some parts of an aircraft, such as an engine blade, are exposed to a cold air stream during the operation of the aircraft. Such exposure may result in the formation then the accretion of ice at the level of a surface of these parts that is exposed to the cold air stream, which may jeopardize the operation of the aircraft.

### DISCLOSURE OF THE INVENTION

One aim of the invention is to prevent the formation and/or accretion of ice at the level of a surface of an aircraft part in a simple, inexpensive and easily industrializable manner.

For this purpose, there is proposed according to one aspect of the disclosure an aircraft part, comprising:
a composite material structure comprising a fibrous reinforcement embedded into a matrix;
at least one heating element configured to heat the part, the heating element being embedded into the matrix of the composite material structure.

Advantageously, but optionally, the part according to the disclosure can comprise the at least one of the following characteristics, taken alone or in combination:
the heating element is distinct from the fibrous reinforcement;
the heating element comprises a support permeable to the matrix and a heating member configured to heat the part;
the heating member comprises an electrically conductive portion, the support being configured to electrically insulate the electrically conductive portion from the fibrous reinforcement;
it further comprises an electrical connection element configured to electrically connect the electrically conductive portion to an electrical power source; and an electrically insulating sheath receiving the electrical connection element so as to electrically insulate the electrical connection element from the fibrous reinforcement;
the support comprises a first layer and a second layer, the heating member being positioned between the first layer and the second layer;
at least one of the first layer and of the second layer comprises a woven portion and/or a knitted portion;
at least one of the first layer and of the second layer comprises a warp knit fabric;
it comprises a plurality of heating elements distributed with a different density according to their position within the part; and
the part is a blade for an aircraft engine, the blade preferably comprising a plurality of heating elements distributed with a different density according to their position within the blade, with a higher density at the level of the root of the blade than at the level of the tip of the blade.

According to another aspect of the disclosure, there is proposed a fan comprising a hub and a plurality of blades as previously described extending radially from the hub.

According to another aspect of the disclosure, there is proposed a method for manufacturing a part as previously described, comprising the steps of:
making the fibrous reinforcement;
fixing the heating element on the fibrous reinforcement; then
solidifying the matrix.

Advantageously, the method can comprise a step of impregnating the heating element with the matrix. Where appropriate, the fixing of the heating element on the fibrous reinforcement can be implemented before or after the step of impregnating the heating element with the matrix. Furthermore, the step of impregnating the heating element with the matrix can be implemented at the same time as a step of impregnating the fibrous reinforcement with the matrix or, alternatively, before or after the step of impregnating the fibrous reinforcement with the matrix.

### DESCRIPTION OF THE FIGURES

Other characteristics, aims and advantages of the disclosure will emerge from the following description, which is purely illustrative and non-limiting, and which should be read in relation to the appended drawings in which:

FIG. 1 is a schematic sectional view of a propulsion assembly for an aircraft.

FIG. 2 is a schematic sectional view of another propulsion assembly for an aircraft.

FIG. 3 illustrates various components of a blade for an aircraft engine.

FIG. 4 illustrates a portion of a blade according to one embodiment.

FIG. 5 is a sectional view of FIG. 4.

FIG. 6 illustrates a blade according to one embodiment.

FIG. 7 is a flowchart showing one mode of implementation of a method for manufacturing a blade.

In all of the figures, similar elements bear identical references.

### DETAILED DESCRIPTION OF THE INVENTION

### Propulsion Assembly

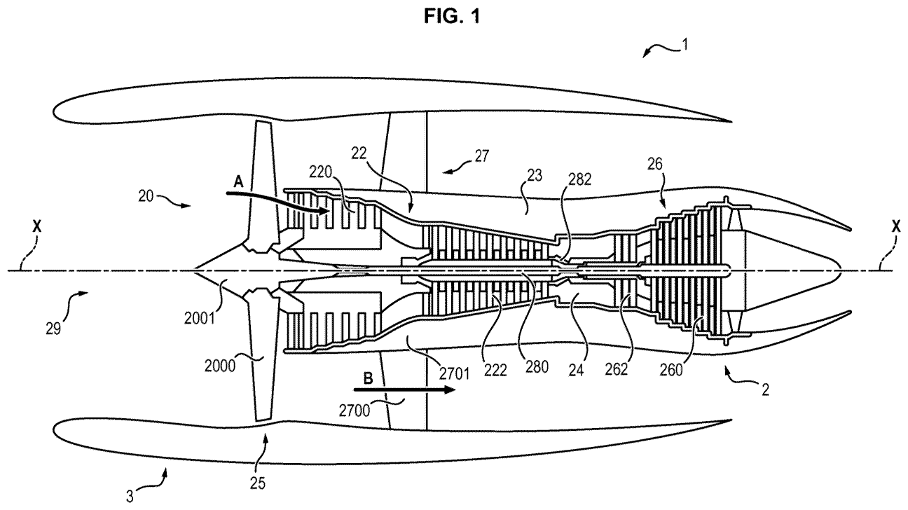

FIG. 1 illustrates a propulsion assembly 1 having a longitudinal axis X-X, and comprising an engine 2 (or turbomachine) and a nacelle 3 surrounding the engine 2.

The propulsion assembly 1 is intended to be mounted on an aircraft (not represented), such as an airplane or a helicopter, for example under the wing of the aircraft, on the wing or at the rear of the fuselage of the aircraft. In this regard, the propulsion assembly 1 can comprise a mast (not represented) intended to connect the propulsion assembly 1 to a portion of the aircraft.

The engine 2 illustrated in FIG. 1 is a twin-spool, turbo-fan, direct-drive turbojet engine. However, this is not limiting since the engine 2 can include a different number of spools and/or streams, and/or be another type of turbojet engine, such as a geared turbofan or a turboprop.

Unless otherwise specified, the terms “upstream” and “downstream” are used in reference to the overall direction of air flow through the propulsion assembly 1 in operation. Similarly, an axial direction corresponds to the direction of the longitudinal axis X-X and a radial direction is a direction perpendicular to the longitudinal axis X-X and intersecting the longitudinal axis X-X. Moreover, an axial plane is a plane containing the longitudinal axis X-X and a radial plane is a plane perpendicular to the longitudinal axis X-X. A circumference is understood as a circle belonging to a radial plane and whose center belongs to the longitudinal axis X-X. A tangential or circumferential direction is a direction tangent to a circumference: it is orthogonal to the longitudinal axis X-X but does not pass through the longitudinal axis X-X. Finally, the adjectives “internal” (or “inner”) and “external” (or “outer”) are used in reference to a radial direction so that the internal portion of an element is, in a radial direction, closer to the longitudinal axis X-X than the external portion of the same element.

As can be seen in FIG. 1, the engine 2 comprises, from upstream to downstream, a fan 20, a compression section 22 comprising a low-pressure compressor 220 and a high-pressure compressor 222, a combustion chamber 24 and an expansion section 26 comprising a high-pressure turbine 262 and a low-pressure turbine 260. The fan 20, the rotor portion of the low-pressure compressor 220, and the rotor portion of the low-pressure turbine 260 are connected together by a low-pressure shaft 280 extending along the longitudinal axis X-X, the fan 20, the low-pressure compressor 220 and the low-pressure turbine 260 then forming a low-pressure body. The rotor portion of the high-pressure compressor 222 and the rotor portion of the high-pressure turbine 262 are interconnected by a high-pressure shaft 282 extending along the longitudinal axis X-X, the high-pressure compressor 222 and the high-pressure turbine 262 then forming a high-pressure body. As can be seen in FIG. 1, the compression section 22, the combustion chamber 24 and the expansion section 26 are surrounded by an engine casing 23, while the fan 20 is surrounded by a fan casing 25. The engine casing 23 and the fan casing 25 are interconnected by profiled structural arms 27 forming rectifiers (or OGV for Outlet Guide Vanes) distributed circumferentially all around the longitudinal axis X-X. The longitudinal axis X-X forms an axis of rotation for the fan 20, the rotor portion of the compression section 22 and the rotor portion of the expansion section 26, which are capable of being driven in rotation about the longitudinal axis X-X relative to the engine casing 23 and to the fan casing 25.

The nacelle 3 extends radially outside the engine 2, all about the longitudinal axis X-X, so as to surround both the fan casing 25 and the engine casing 23, and to define, with a downstream portion of the engine casing 23, a downstream portion of a secondary flowpath B, the upstream portion of the secondary flowpath B being defined by the fan casing 25 and an upstream portion of the engine casing 23. The upstream portion of the nacelle 3 further defines an air inlet 29 through which the fan 20 sucks in the air stream circulating through the propulsion assembly 1.

In operation, the fan 20 sucks in an air stream, a portion of which, circulating within a primary flowpath A, is successively compressed within the compression section 22, ignited within the combustion chamber 24 and expanded within the expansion section 26 before being ejected out of the engine 2. The primary flowpath A passes through the engine casing 23 from one side to the other. Another portion of the air stream circulates within the secondary flowpath B which takes an elongated annular shape surrounding the engine casing 23, the air sucked in by the fan 20 being rectified by the rectifiers 27 then ejected out of the propulsion assembly 1. In this way, the propulsion assembly 1 generates a thrust. This thrust can for example be used for the benefit of the aircraft onto which the propulsion assembly 1 is added and fixed.

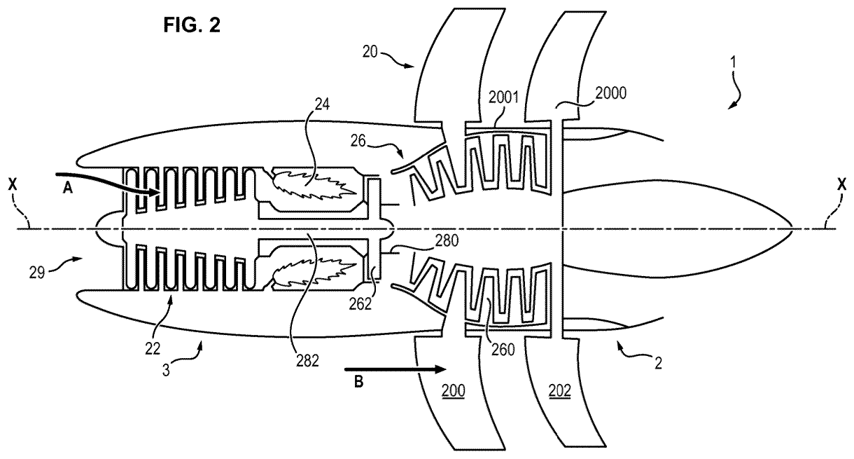

FIG. 2 illustrates another propulsion assembly 1, also having a longitudinal axis X-X, and also comprising an engine 2, as well as a nacelle 3.

Unlike the engine 2 of the propulsion assembly 1 illustrated in FIG. 1, the engine 2 of the propulsion assembly 1 illustrated in FIG. 2 does not comprise a ducted fan 20, but an unducted fan 20 (or propeller). The nacelle 3 is, for its part, intended to be fixed to the aircraft, in the same way as for the propulsion assembly 1 illustrated in FIG. 1, and also defines an air inlet 29. The propulsion assembly 1 illustrated in FIG. 2 is of the Open-Rotor type, more particularly in a configuration called “pusher”, that is to say in which the unducted fan 20 is positioned downstream of the engine 2 and downstream of the air inlet 29. This is however not limiting, since a propulsion assembly 1 of the Open-Rotor type can also be in a configuration called “puller”, in which the fan 20 is positioned upstream of the engine 2, the air inlet 29 being positioned upstream of the fan 20, between the two rotor stages 200, 202 of the fan 20, or downstream of the fan 20.

In FIG. 2, the fan 20 comprises two counter-rotating rotor stages 200, 202, i.e., in operation, the rotor stages 200, 202 are driven in rotation about the longitudinal axis X-X in opposite directions. This is however not limiting, since the fan 20 can also comprise a rotor stage, driven in rotation about the longitudinal axis, and a stator stage, fixed in rotation, the stator stage being positioned downstream of the rotor stage, and behaves as a rectifier in order to rectify the air stream sucked in by the rotor stage. Generally, the rotor stages 200, 202 of an open-rotor rotate less quickly than a ducted fan 20. Furthermore, the length of the blade airfoils 2000 of the fan 20 is greater for a propulsion assembly 1 as illustrated in FIG. 2 than for a propulsion assembly 1 as illustrated in FIG. 1. The fan 20 blades 2000 of a propulsion assembly 1 as illustrated in FIG. 2 are therefore particularly sensitive to the phenomenon of ice accretion. Furthermore, unlike a ducted fan 20, the entire surface of the blades 2000 of the rotor stages 200, 202 of the fan 20 of an open-rotor can be the location of icing.

As visible in FIG. 2, the engine 2 comprises, from upstream to downstream, a compression section 22, a combustion chamber 24 and an expansion section 26 comprising a high-pressure turbine 262 and a low-pressure turbine 260. The rotor portion of the high-pressure turbine 262 is connected to at least a portion of the rotor portion of the compression section 22 by a high-pressure shaft 282 extending along the longitudinal axis X-X. The low-pressure turbine 260 comprises two rotors, each secured in rotation to the rotor stages 200, 202 of the fan 20. This is however not limiting since, when the fan 20 comprises a rotor stage and a stator stage, a rotor portion of the low-pressure turbine 260 is connected to the rotor stage of the fan 20, while a stator portion of the low-pressure turbine 260 is connected to the stator stage of the fan 20. The compression section 22, the combustion chamber 24 and the expansion section 26 are surrounded by the nacelle 3.

In operation, each of the fan 20 and of the compression section 22 sucks in an air stream. The air A sucked in by the compression section 22 is successively compressed within the compression section 22, ignited within the combustion chamber 24 and expanded within the expansion section 26 before being ejected out of the engine 2. The air B sucked in by the fan 20 circulates around the nacelle 3 before being ejected downstream of the propulsion assembly 1. In this way, the propulsion assembly 1 generates a thrust. This thrust can for example be used for the benefit of the aircraft onto which the propulsion assembly 1 is added and fixed.

The engine 2 of each of the propulsion assemblies illustrated in FIG. 1 and FIG. 2 comprises at least one rotor, typically the fan 20, and a stator, typically the rectifier 27, which each comprise a hub 2001, 2701, centered on the longitudinal axis X-X, and from which a plurality of blades 2000, 2700 extend radially.

### Blade for Engine

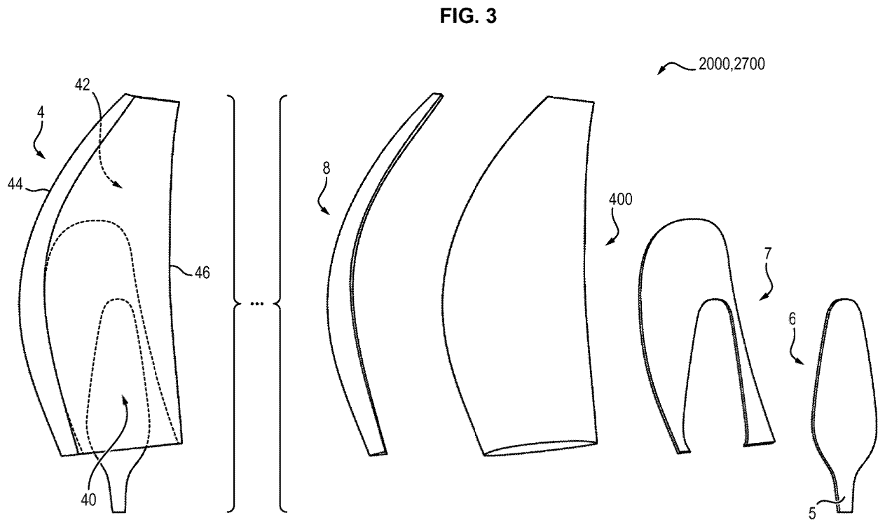

As visible in FIG. 3, at least one among the blades 2000, 2700 of the engine 2, typically all the blades 2000, 2700 of the fan 20 and of the rectifier 27, comprises an airfoil 4 and a root 5, the root 5 making it possible to fix the blade 2000, 2700 to the hub 2001, 2701. The blade 2000, 2700, and more particularly the airfoil 4, can comprise a composite material structure comprising a fibrous reinforcement embedded into a matrix. This indeed makes it possible to optimize the mass of the propulsion assembly 1 and improves its performance.

The fibrous reinforcement can be formed from a single-piece fibrous (or textile) preform, obtained by three-dimensional or multi-layer weaving, with evolving thickness. It can comprise warp and weft strands. Three-dimensional weaving generally indicates that the warp strands follow meandering paths in order to interconnect weft strands belonging to different weft strand layers except for non-interlinkings, it being noted that a three-dimensional weaving, in particular an interlock weave, can include 2D surface weavings. Different weaves of three-dimensional weaving can be used, such as multi-satin or multi-plain interlock weaves. The fibrous reinforcement can thus comprise woven (two-dimensional or three-dimensional), braided, knitted or laminated fibrous arrangements. The fibers of the fibrous reinforcement can comprise one of the following materials: carbon, glass, basalt, aramid, polypropylene and/or ceramic.

The matrix typically comprises an organic material (thermosetting, thermoplastic or elastomeric material) or a carbon matrix. For example, the matrix comprises a plastic material, typically a polymer, for example epoxy, bismaleimide or polyimide.

The airfoil 4 has, at least on a portion, an aerodynamic profile suitable for being placed in a stream when the propulsion assembly 1 is in operation, in order to generate lift. The aerodynamic profile comprises an intrados 40, an extrados 42, a leading edge 44 and a trailing edge 46. The leading edge 44 is configured to extend facing the air flow within the propulsion assembly 1, and corresponds to the anterior portion of an aerodynamic profile which faces the air stream and which divides the air flow into an intrados flow 40 and an extrados flow 42. The trailing edge 46, for its part, corresponds to the posterior portion of the aerodynamic profile, where the intrados 40 and extrados 42 flows meet. The intrados 40 or the extrados 42 of the airfoil 4 can be covered with a polyurethane film for the protection against erosion.

In one embodiment (not represented), the airfoil can comprise two skins, which are connected to each other and extend generally facing each other. The skins are shaped so as to define the aerodynamic profile together. The skins are made of a composite material comprising the fibrous reinforcement densified by a matrix. They are therefore monolithic and made in a single piece according to a non-limiting embodiment. As a variant, it is possible to consider a fibrous reinforcement for the intrados and another for the extrados.

In one embodiment illustrated in FIG. 3, the blade 2000, 2700 further comprises a spar 6, a filler piece 7 and a shield 8.

The spar 6 can comprise, as illustrated in FIG. 3, a blade root portion 5 which extends outside the airfoil 4 and an airfoil portion which is disposed inside the airfoil 4 so as to form a core thereof. The blade root portion 5 is configured to be inserted into the hub 2001, 2701. The spar 6 can be made of metal and in a single piece, in which the blade root portion 5 and the airfoil portion are monolithic. The metal material of the spar 6 can comprise the at least one of the following materials: steel, titanium, titanium alloy (particularly TA6V, comprising titanium, aluminum, vanadium and traces of carbon, iron, oxygen and nitrogen), nickel-based superalloy such as Inconel, aluminum alloy. As a variant, the spar 6 can comprise a composite material comprising a fibrous reinforcement densified by a matrix. In a manner similar to the composite material structure of the airfoil 4, the matrix of the spar 6 typically comprises an organic material (thermosetting, thermoplastic or elastomer material) or a carbon matrix. For example, the matrix comprises a plastic material, typically a polymer, for example epoxy, bismaleimide or polyimide. The fibers of the fibrous reinforcement of the spar 6 comprise at least one of the following materials: carbon, glass, basalt, aramid, polypropylene and/or ceramic. The fibrous reinforcement of the spar 6 can comprise woven (two-dimensional or three-dimensional), braided, knitted or laminated fibrous arrangements. The matrix of the spar 6 and the matrix of the composite material structure of the blade 2000, 2700 can, where appropriate, be identical. The fibers of the fibrous reinforcement of the spar 6 can be made of a material identical to or different from the fibers of the fibrous reinforcement of the composite material structure of the blade 2000, 2700. Ultimately, the spar 6 is preferably made of composite material with an organic epoxy matrix reinforced with 3D woven carbon fibers with the warp direction predominantly oriented radially and the weft predominantly oriented along the chord of the airfoil 4 at the height of the aerodynamic flowpath. However, the spar 6 can also be a more mechanically advantageous assembly of different organic-matrix composite materials (thermosetting, thermoplastic or elastomer) reinforced by long fibers (carbon, glass, aramid, polypropylene) in several fibrous arrangements (woven, braided, knitted, unidirectional).

The filler piece 7 is placed within the aerodynamic profile structure of the airfoil 4 and surrounds the spar 6. The filler piece 7 can be made of a material including inner cavities, such as a foam of organic origin (polyethacrylimide, polyethylene terephthalate (PET), polyvinyl chloride (PVC), polyetherimide (PEI), polyvinyl, carbon, polyisocyanurate, polyurethane, etc.) or metal origin (in particular aluminum alloy), or a honeycomb of the Nomex®, Kevlar, fiberglass or aluminum type. Advantageously, the filler piece 7 is covered with a skin made of organic-matrix composite material 400 to increase the resistance of the blade 2000, 2700 to impact.

Finally, the leading edge 44 of the aerodynamic profile can be reinforced by a shield 8 added and fixed, for example by bonding. The shield 8 can be titanium or titanium alloy, stainless steel, steel, aluminum, nickel, etc.

### Heating Element

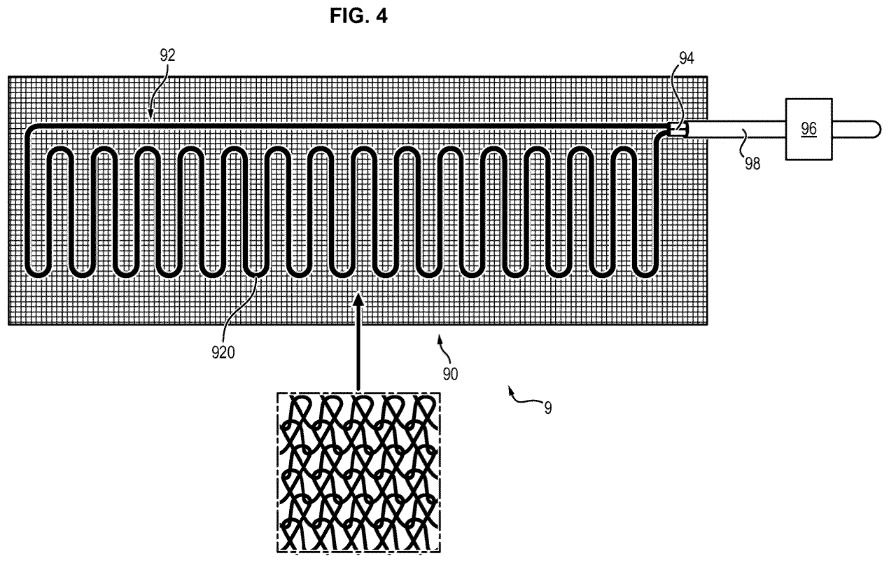

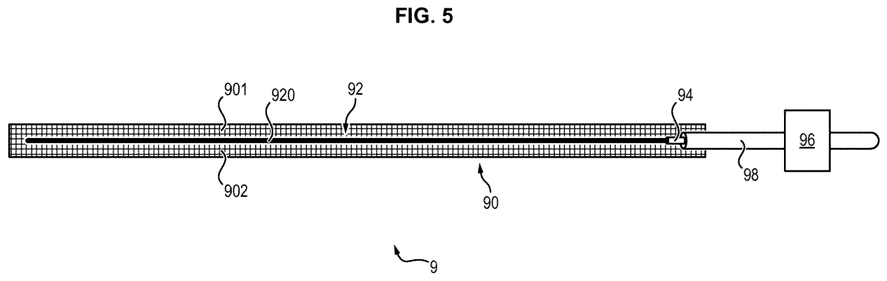

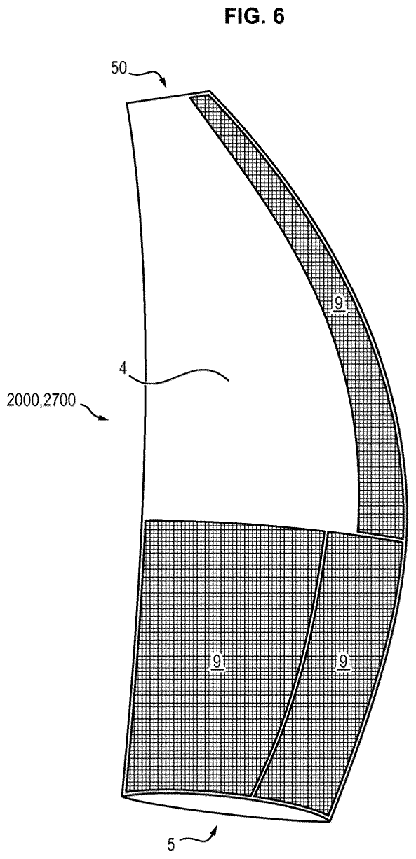

FIG. 4 and FIG. 5 illustrate a heating element 9 configured to heat the blade 2000, 2700, and FIG. 6 illustrates that the heating element 9 is added and fixed onto the blade 2000, 2700 by being embedded into the matrix of the composite material structure. The fan 20 blades 2000 and the rectifier 27 blades 2700 are particularly sensitive to the phenomenon of ice and/or frost accretion, and it is therefore particularly advantageous for the heating element 9 to be added and fixed onto this type of blade 2000, 2700.

It should however be noted that the heating element 9 is distinct from the fibrous reinforcement of the composite material structure, onto which it is added and fixed. The heating element 9 can be sewn onto the fibrous reinforcement, preferably with stitches at the ends of the heating element 9, or bonded, or even fixed to the fibrous reinforcement by means of inserts, for example of the Parisian drawing pin type.

As visible in FIG. 4 and FIG. 5, the heating element 9 comprises a support 90 and a heating member 92.

The heating member 92 is configured to heat the blade 2000, 2700. Preferably, as illustrated in FIG. 4 and FIG. 5, the heating member 92 operates on electrical energy and heats the blade 2000, 2700 by Joule effect by dissipating electric current circulating through it. This is however not limiting since the heating member 92 can also be of the chemical type, and provide heat by chemical reaction of components internal to the heating member 92, or hydraulic reaction, and provide heat by heat conduction of a heat transfer fluid circulating through the heating member 92. In any event, FIG. 4 and FIG. 5 illustrate that the heating member 92 comprises an electrically conductive portion 920, which is configured to heat the blade 2000, 2700. The electrically conductive portion 920 may take the form of a serpentine, as illustrated in FIG. 4, in order to optimize the distribution of the heat produced by the heating member 92. The serpentine comprises a certain number of portions of electrical wires which are bent, identical or not identical to each other, and connected to each other, for example by being integral with each other, i.e. by being obtained in one piece with each other. Preferably, the heating member 92 comprises a metal, such as copper, because it is a material that conducts heat well. In any event, the patterns, the material and the section of the electrically conductive elements in the electrically conductive portion 920 are parameters that can be adjusted according to the heating requirement. It is nevertheless appropriate for the heating member, and therefore for the electrical wires that compose it where appropriate, to be sufficiently flexible to match the shape of the blade 2000, 2700.

As illustrated in FIG. 4 and FIG. 5, the support 90 is permeable to the matrix, that is to say it is configured to be impregnated with the matrix. Furthermore, in particular when the heating member 92 operates on the electrical energy and comprises an electrically conductive portion 920, the support 90 is configured to electrically insulate the electrically conductive portion 920 from the fibrous reinforcement, which is generally electrically conductive. This makes it possible to avoid the creation of current loops in the blade 2000, 2700, which could damage it. Advantageously, as visible in FIG. 5, the support 90 comprises a first layer 901 and a second layer 902, the heating member 92 being positioned between the first layer 901 and the second layer 902. This makes it possible to improve the electrical insulation of the heating member 92 with respect to the fibrous reinforcement. Returning to FIG. 4, the at least one of the first layer 901 and of the second layer 902 can comprise a woven portion and/or a knitted portion, which make it possible to obtain the required matrix permeability, since it has sufficient porosity. In one advantageous variant, the at least one of the first layer 901 and of the second layer 902 can comprise a marquisette fabric, typically made of warp knit, which is illustrated in FIG. 4, whose matrix permeability is optimal, i.e. it has meshes that are wide enough for the matrix stream not to be disturbed, and narrow enough to guarantee the electrical insulation of the electrically conductive portion 920. The warp knit fabrics are made from warp loops formed in length and interlaced in the width of the knit. Such knits have the advantage of not having its meshes undone. Generally, the support 90 can comprise any polymer that is not electrically conductive and is also sufficiently heat resistant, i.e. it does not deteriorate at temperatures ranging from 50° C. to 100° C. Alternatively or additionally, both the first layer 901 and the second layer 902 are as described above, or even identical.

When the heating member 92 is of the electric type, as visible in FIG. 4 and FIG. 5, it is possible to provide for an electrical connection element 94 configured to electrically connect the electrically conductive portion 920 of the heating member 92 to an electrical power source 96. This electrical connection element 94 can extend outside the support 90, typically along the root 5 of the blade 2000, 2700. Therefore, to prevent the electrical connection element 94 from establishing electrical contact with the fibrous reinforcement, it is possible to provide for an electrically insulating sheath 98 receiving the electrical connection element 94 so as to electrically insulate the electrical connection element 94 from the fibrous reinforcement.

Thus, as visible in FIG. 6, the heating element 9 can take the form of a mat integrated into the blade 2000, 2700, at the level of all or part of an outer surface of the blade 2000, 2700. The mat form is however not limiting, since it is entirely possible to envisage different patches, distributed over the entire surface of the blade 2000, 2700. Depending on the areas of the blade 2000, 2700 exposed to a cold air stream, it is possible to densify some portions with a heating element 9 configured to dissipate a greater amount of heat, typically whose electrically conductive portion 920 has a greater circulating electrical power, that it dissipates by Joule effect, for example whose electrically conductive portion 920 comprises thicker electrical wires. Where appropriate, it is possible to provide for an electrical network (with a power supply and an electrical connection element 94) per heating member 92 or, on the contrary, a single electrical network connected to all of the heating members, but where the surface density of the electrical wires of the different heating members varies according to their positioning on the blade 2000, 2700. Typically, ice accretion is generally more frequent and more significant at the level of a portion of the airfoil 4 which is close to the root 5 of the blade 2000, 2700. The electrical network of the heating member 92 is therefore denser there than at the tip 50 of the blade 2000, 2700 where the accretion is rarer, due to the speeds reached during the rotation of the blade 2000, 2700 about the longitudinal axis X-X. Different heating elements 9 can therefore be provided on the surface of the blade 2000, 2700, preferably by being distributed with a different density according to their position within the blade 2000, 2700. The density of the heating elements 9 corresponds here to the number of heating elements 9 per unit of space, this unit being able to be a surface or volume unit. Thus, in the advantageous case where the heating elements 9 are distributed with a higher density at the level of the root 5 of the blade 2000, 2700 than at the level of the tip 50 of the blade 2000, 2700, this means that the number of heating elements per unit of surface and/or volume is higher in a region located at the level of the root 5 of the blade 2000, 2700 than in a region located at the level of the tip 50 of the blade 2000, 2700, as for example visible in FIG. 6.

### Manufacturing Method

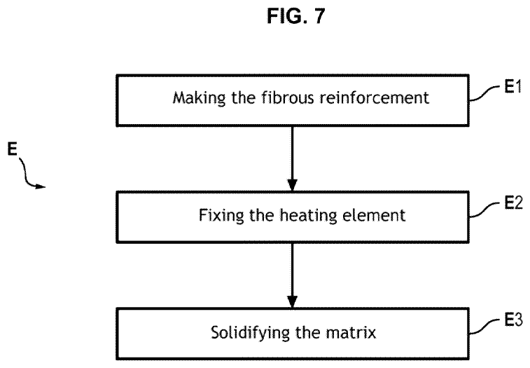

With reference to FIG. 7, a method E for manufacturing a blade 2000, 2700 for an engine 2 such as previously described, generally comprises making E1 the fibrous reinforcement, fixing E2 the heating element 9 on the fibrous reinforcement and solidifying E3 the matrix.

One way of carrying out this manufacturing method E consists in using a method for injecting resin under vacuum called RTM (Resin Transfer Molding) or VARTM (Vacuum Assisted Resin Transfer Molding) process. This method generally consists in preparing a fibrous preform by three-dimensional weaving and then arranging this preform in a mold and injecting a polymerizable resin therein such as an epoxy resin, which is the matrix that will impregnate the preform, by possibly maintaining a reduced pressure during the impregnation (in the case of the VARTM). After polymerization and hardening of the airfoil 4, and more specifically of the skin made of organic-matrix composite material 400 where appropriate, that is to say after solidification E3 of the matrix, the leading edge 44 of the airfoil 4 is reinforced by the shield 8, preferably metallic shield, which is added and fixed, for example by bonding. The polymerization is a form of solidification E3 of the matrix, as is also the thermosetting. Thus, the solidification E3 of the matrix may or may not require the supply of external heat. Where appropriate, the manufacturing method E comprises a curing step. Of course, other methods for solidifying E3 the matrix can be envisaged, which depend in particular on the composition of the matrix.

The heating element 9 can typically be added and fixed E3 onto the fibrous reinforcement within the mold, typically by bonding, before the matrix is injected, so that the latter can impregnate both the fibrous reinforcement and the heating element 9. This is however not limiting, since the heating element 9 can also be added and fixed onto the fibrous reinforcement after the latter has been impregnated with the matrix, the heating element 9 then being impregnated with the matrix before its solidification E3. Advantageously, the position of the heating element 9 on the fibrous reinforcement can be controlled by means of a laser.

In what has been described above, the heating element 9 and the fibrous reinforcement are impregnated with the matrix in the mold. This is however not limiting, since it is also possible to pre-impregnate the heating element 9 and/or the fibrous reinforcement with the matrix, then to add and fix the heating element 9 onto the fibrous reinforcement, before solidification E3 of the matrix.

Once the matrix has solidified, it is possible to provide a step of machining the blade 2000, 2700 to give it the desired aerodynamic profile, and this before adding and fixing the shield 8 at the level of the leading edge 44.

The manufacture of the spar 6 can for its part involve several specific methods such as for example machining, forging, forming, casting or additive manufacturing (3D printing).

Where appropriate, the spar 6 and the filling part 7 are inserted within the composite material structure before the step E3 of solidifying the matrix, typically by curing.

Steps of controlling the blade 2000, 2700 can be provided in order to check its mechanical strength before fixing it to the hub 2001, 2701.

### Advantages Obtained

By embedding the heating element 9 into the matrix of the composite material structure of the blade 2000, 2700, various advantages are obtained.

First of all, this eliminates the need to use a heating mat added and fixed onto a portion of the outer surface of the blade, typically between the blade and the protective shield added and fixed onto the leading edge of the blade. Getting rid of such a heating mat makes it possible to obtain a blade that does not have any excess thickness, which would be likely to penalize the aerodynamic properties of the blade or limit the possibility of using the protective shield, since the adhesion at the level of excess thickness would be weaker. And a degraded arrangement of the protective shield would compromise the mechanical strength of the blade, especially in the event of impact from a foreign body.

Furthermore, the heating element is less sensitive to corrosion than the heating mat would be. Finally, the method for manufacturing the blade is simpler and less expensive than adding and fixing a heating mat, because it is more easily repeatable on a large scale.

Then, this eliminates the need to heat the blade using hot air taken from the engine. Getting rid of a de-icing system by taking hot air allows reducing the complexity and the mass of the engine, which then no longer comprises the ducts for conveying hot air from the engine to the parts to be de-iced. Furthermore, this allows reducing the complexity of manufacturing the blades, which no longer need to comprise inner conveying ducts to receive the hot air.

Finally, this eliminates the need to provide that the blade is deformable under the inner pressure of a fluid to break the ice accumulated at the level of an outer surface of the blade, as for a leading edge of an aircraft wing. Such geometric modifications to the blade would indeed be too penalizing for the efficiency of the engine.

Although a heating element added onto a blade for an aircraft engine has been described, this is however not limiting. Indeed, an aircraft can also comprise other parts comprising a composite material structure, which can also integrate a heating element, an electrical connection element and/or an electrically insulating sheath as previously described. Such parts can be portions of the aircraft fuselage or of the nacelle. Furthermore, such composite material parts can be manufactured according to the manufacturing method previously described.

1-11. (canceled)

12. An aircraft part comprising:
a composite material structure comprising a fibrous reinforcement and a matrix, the fibrous reinforcement being embedded into the matrix; and
a plurality of heating elements configured to heat the aircraft part, each of the plurality of heating elements being embedded into the matrix of the composite material structure, the plurality of heating elements being distributed across the aircraft part with a density depending on a position in the aircraft part.

13. The aircraft part of claim 12, wherein each of the plurality of heating elements is distinct from the fibrous reinforcement of the composite material structure.

14. The aircraft part of claim 12, wherein each of the plurality of heating elements comprises a support and a heating member, the support being permeable to the matrix and the heating member being configured to heat the aircraft part.

15. The aircraft part of claim 14, wherein the heating member comprises an electrically conductive portion, the support being configured to electrically insulate the electrically conductive portion from the fibrous reinforcement of the composite material structure.

16. The aircraft part of claim 15, further comprising an electrical connection element and an electrically insulating sheath, the electrical connection element being configured to electrically connect the electrically conductive portion to an electrical power source and the electrically insulating sheath receiving the electrical connection element so as to electrically insulate the electrical connection element from the fibrous reinforcement of the composite material structure.

17. The aircraft part of claim 14, wherein the support comprises a first layer and a second layer, the heating member being positioned between the first layer and the second layer.

18. The aircraft part of claim 17, wherein at least one of the first layer and of the second layer comprises a woven portion and/or a knitted portion.

19. The aircraft part of claim 17, wherein at least one of the first layer and of the second layer comprises a warp knit fabric.

20. The aircraft part of claim 12, wherein the aircraft part is a blade of an aircraft engine, the blade having a root and a tip, the plurality of heating elements being distributed across the blade with a higher density at the root than at the tip.

21. A fan comprising a hub and a plurality of blades, each of the plurality of blades being the blade of claim 20 and extending radially from the hub.

22. A method for manufacturing the aircraft part of claim 12, the method comprising making the fibrous reinforcement, fixing the plurality of heating elements on the fibrous reinforcement and then solidifying the matrix.
